(19) United States
(12) Patent Application Publication
(10) Pub. No.: US 2012/0117041 A1
(43) Pub. Date: May 10, 2012

(54) DEBUGGING A STORED PROCEDURE IN A DATABASE

(75) Inventors: John Rodriguez, Capitola, CA (US); George Hillenbrand, Rochester, NY (US)

(73) Assignee: VeriSign, Inc., Dulles, VA (US)

(21) Appl. No.: 12/941,528

(22) Filed: Nov. 8, 2010

(51) Int. Cl. G06F 7/00

(52) U.S. Cl. 707/702; 707/E17.032

(57) ABSTRACT

This invention provides tools and methods for debugging a stored procedure in a database. The methods allow for debugging of the stored procedure even when it is invoked over a normal connection to a database management system, for example using ODBC. The developer can debug the stored procedure using an integrated development environment, including viewing the values of variables and the position of the execution pointer as the stored procedure executes. The invention also provides methods for allowing the developer for changing the source code of the stored procedure during debugging.

### BACKGROUND OF THE INVENTION

A database or database system may contain data organized into a number of tables. An application making use of the database may obtain information from the database by sending queries to the database system. The queries may be in the form prescribed by a query language such as the Structured Query Language (SQL) and the Object Query Language (OQL). The application may make use of a standardized Application Programming Interface (API) for communicating with a database system such as the Open Database Connectivity (ODBC) or the Java Database Connectivity (JDBC). The API may in turn make use of a driver to submit the query to the database system. The driver may relate to a particular Relational Database Management System (RDBMS) or Database Management System (DBMS), and may implement proprietary protocols relating to a particular RDBMS. For the remainder of this document, DBMS will be used as a collective term for RDBMS and DBMS. The API may also make use of standardized network protocols, including the Transmission Control Protocol (TCP) and the Internet Protocol (IP) to communicate with the RDBMS.

Some DBMS enable queries to be made with reference to a procedure or function stored at the DBMS known as a stored procedure. A stored procedure may be called using an API such as ODBC and may, like a normal database query, return a number of rows of data to the caller. Stored procedures may take a number of variables as input and use those to determine what queries to make to the database.

A database query or a call to a stored procedure is often made from a database client application. The DBMS may run on a server or cluster of servers connected to a network. The database client may run on a different computer connected to a network enabling it to communicate with the DBMS. The database client may be a web application accessible to a user via a web browser. Before invoking the stored procedure, the database client may prepare a number of variables and send them to the server as parameters for the stored procedure it calls. The DBMS will then execute the procedure and send the results back to the client. The client may apply additional processing before presenting them to the user of the application.

In some DBMS stored procedures resemble queries and are prepared in languages that resemble query languages, but have additional syntax to control execution flow. These languages include Transact-SQL (T-SQL), implemented in Microsoft SQL Server; and SQL/PSM (Persistent Stored Modules). Stored procedures may also be implemented in other programming languages, including Java, C, C# and LUA. Such implementations may rely on extensions to the language or libraries enabling access to the database system.

When the database system receives a call to the stored procedure it will execute the procedure and send the results to the caller. The stored procedure can be executed in a number of different ways. On some DBMS, the stored procedure is interpreted line by line as it is stored in the database system using an interpretation module. A DBMS may implement stored procedures that are external computer programs which are executed when the stored procedure is called; these programs often run independently of the database system and communicate with it over a predefined calling protocol. In other DBMS, stored procedures are translated to an intermediary language before being stored on the database. The intermediate-language-version of the stored procedure may then be executed by interpretation under the control of the database system. A DBMS may also use just-in-time compilation to execute intermediary language.

Like a computer program, a stored procedure may contain programming errors or bugs. When developing a computer program it is common to debug the program using a debugger. Debuggers may rely on additional code being inserted into the program being debugged in order to track variables and exceptions and make relevant debugging information available to the debugger.

There are a number of commercial database systems that include means for debugging stored procedures. Stored procedures on a Microsoft SQL Server may be debugged from the Microsoft Visual Studio Integrated Development Environment (IDE). In order to debug the procedure, the procedure must be called from the IDE, where the caller can specify the parameters to pass to the procedure. The results of the stored procedure and any debugging information is displayed in the IDE. The IBM DB2 platform also offers debugging of some stored procedures, including some implemented in C and SQL. These stored procedures are compiled into native code on the database server and interact with the database using a calling interface. A mapping between the language the stored procedure is written in and the native code output is used. Similarly, additional debugging hooks are added to the native code to enable debugging in a manner similar to that used when debugging normal applications. The debugger itself works like a debugger for a computer program executing natively; additional debugging code is inserted into the compiled stored procedure to detect and track exceptions and when an exception occurs, debugging information is assembled.

Debugging a procedure in an IDE does not enable a developer to test an application in its runtime environment. This difference can make the debugging process less effective. Some of the disadvantages include: the request to invoke a stored procedure sent through the IDE may not be identical to that the client would send, and certain bugs may accordingly not be detected; the results will not be processed by the client application, and irregularities in the results may therefore be more difficult to detect.

### SUMMARY OF THE INVENTION

Embodiments of the invention provide methods for debugging a stored procedure on a database server using an integrated development environment (IDE) or other tool.

The process may begin by a user selecting a stored procedure in a database in the IDE, and specifying a number of criteria for determining which calls to invoke the stored procedure should be debugged. The IDE may then send a request to the database server with this information.

The database server may then receive a request to invoke the stored procedure from a client application. The client application may be a computer program adapted to request information from the database and display it to the user.

The database server may determine that the call to invoke the stored procedure meets the criteria in the request from the IDE, and that debugging information should therefore be sent.

The database server may then begin executing the stored procedure by interpreting the code line by line in a code interpretation module in the DBMS. The DBMS may instruct the interpreter to execute the stored procedure in debugging mode. The database server may send a message to the IDE informing it that execution of the stored procedure has started and including the parameters contained in the call to the stored procedure.

The interpreter may then determine that a breakpoint in the code in the stored procedure has been reached, and send debugging information to the IDE including information about the current position of the execution pointer and the values of variables.

The user may then review the information in the IDE, and via the IDE instruct the database server to resume execution of the stored procedure. The interpreter may then resume execution of the stored procedure. When the interpreter reaches the end of the stored procedure, it may send the results of the stored procedure to the client application and send debugging information indicating that execution of the stored procedure completed execution to the IDE.

### BRIEF DESCRIPTION OF THE DRAWINGS

FIG. 1 shows a web page form that lets a user register their name and address in order to submit the data to the DBMS which will run a stored procedure that can then be debugged using an embodiment of the invention.

FIG. 2 shows the structure of a system that uses a stored procedure that may be debugged using the an embodiment invention.

FIG. 3 shows the structure of a system that uses a stored procedure that may be debugged using an embodiment of the invention.

FIG. 4 shows an integrated development environment (IDE) displaying the code of a stored procedure titled “new_user.java” in accordance with an embodiment of the invention.

FIG. 5 shows the IDE of FIG. 4, also showing a dialog allowing a user to specify conditions for which calls to the stored procedure should trigger debugging in accordance with an embodiment of the invention.

FIG. 6 depicts a diagram showing the internal structure at a database server in an embodiment of the invention.

FIG. 7 depicts a diagram showing the internal structure at a DBMS in an embodiment of the invention.

FIG. 8 depicts a diagram showing the internal structure at a DBMS in an embodiment of the invention.

FIG. 9 depicts a diagram showing the internal structure at a DBMS in an embodiment of the invention.

FIG. 10 depicts a diagram showing the internal structure at a database server in an embodiment of the invention.

FIG. 11 shows the IDE of FIG. 4 during debugging of the stored procedure “new_user.java” in accordance with an embodiment of the invention.

FIG. 12 shows the communications between an IDE, a DBMS and a Client in an embodiment of the invention.

### DETAILED DESCRIPTION OF THE INVENTION

Embodiments of the present invention relate to methods for debugging a stored procedure in a database, methods for controlling the execution of a stored procedure while debugging it and methods for collecting information relevant to the debugging of a stored procedure. The stored procedure may be executed on a DBMS after being called by a database client.

The DBMS may contain a number of databases, each of which comprises a number of tables and stored procedures. Each table may be a collection of rows of data divided into columns.

The data in the tables may be accessed using one or more of the stored procedures. In an embodiment of the invention, a stored procedure can be invoked by passing a message over a network including the name of the database, the name of the stored procedure, and a number of parameters to pass to the stored procedure. The stored procedure may then be executed on the DBMS, database server or elsewhere. Executing the stored procedure may include reading data in one or more tables and changing data in one or more tables. Once the stored procedure is finished executing, information about the execution, such as whether it was successful or not may be sent from the DBMS to the computer that sent the message to invoke the stored procedure.

A stored procedure may be invoked from a number of different types of applications. It may be invoked directly from a database console. A stored procedure may also be invoked from within another application. Such an application can be a desktop application such as Microsoft Access or Microsoft Word, or it can be a network based or web based application such as an online shopping cart, or a Domain Name System (DNS) resolution platform.

In an embodiment of the invention, the database client is a web application running on a web server, which sends queries to a DBMS using JDBC. The web server and the DBMS may be connected to a network and may communicate using TCP. The application may include a form that a user can fill out to register with the website. When the user clicks a register button on the form, a stored procedure on the DBMS is invoked, and the data entered on the form is passed to the stored procedure on the DBMS. The stored procedure may first validate the data to make sure that it is acceptable to insert into the database. For example, it may verify that there is a first name and a last name, and that the full name does not already exist in the database. Furthermore, it may also verify that the e-mail address supplied is in the correct format, and that the chosen username is not already in the database. If the data is properly validated, the stored procedure may register the user by inserting the data in a table of users in the database, and notify the website that the registration was successful. A confirmation page may be displayed to the user. If the data was not successfully validated, the stored procedure may send information about the validation failure to the website. The website may then display information about the failure on the registration form, and let the user amend the data before submitting the form again.

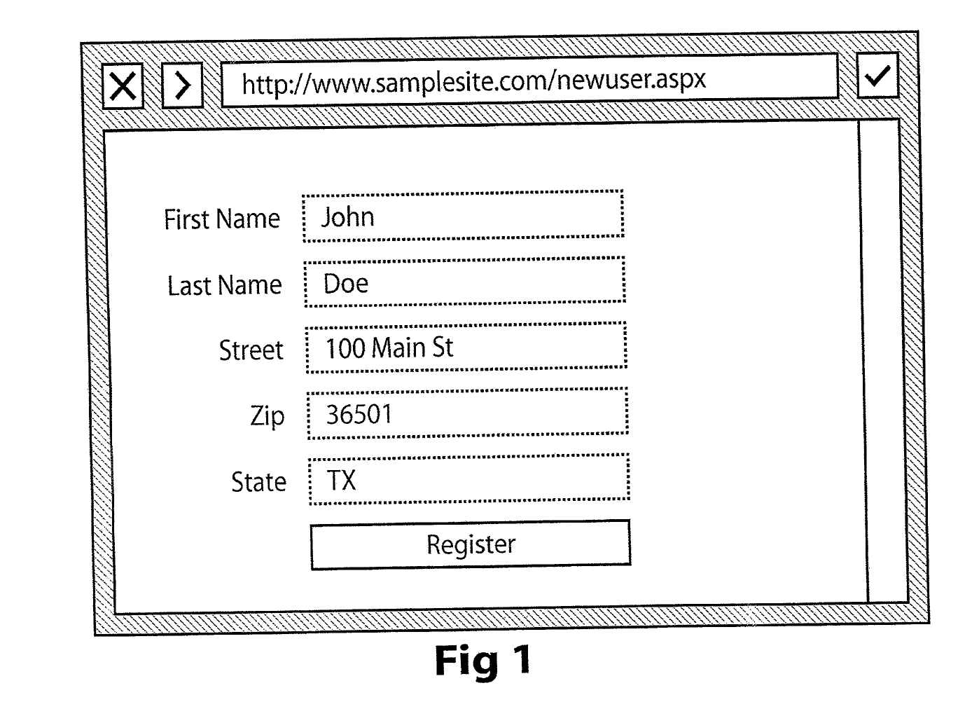

FIG. 1 shows a web page that lets a user register its name and address in accordance with an embodiment of the invention. The user can enter its information into the fields on the page, and click the “Register” button to submit the information to the web server hosting the web page, and register. The web server may call a stored procedure to register the user, and pass the information received from the form to the stored procedure.

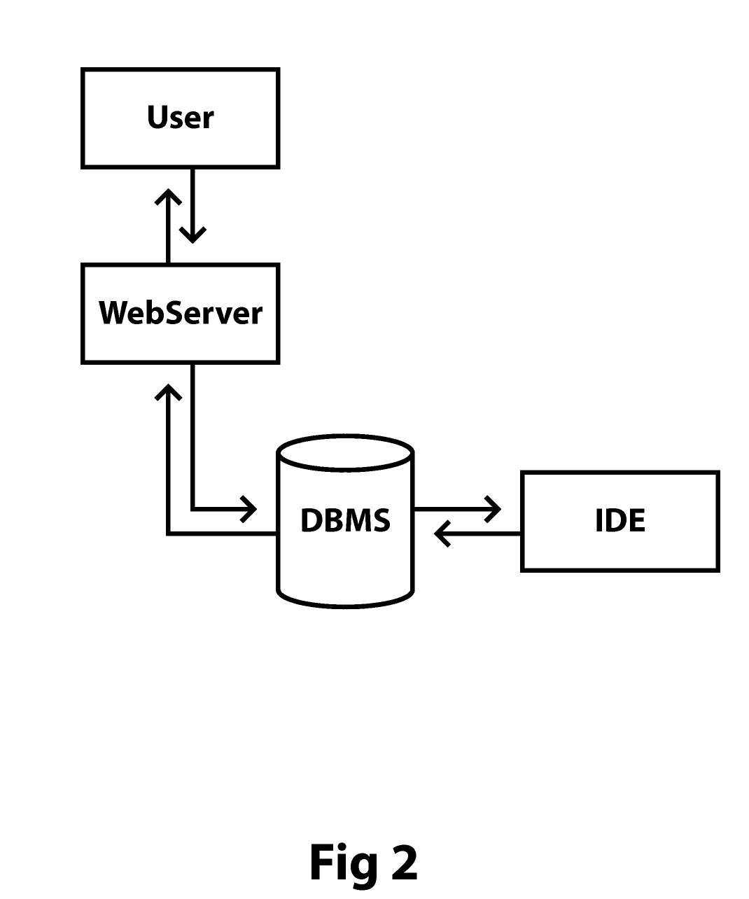

FIG. 2 shows the structure of a system that uses a stored procedure that may be debugged using and embodiment of the invention. The system includes a web server, a DBMS and an IDE as well as a user that requests a web page from the web server. The IDE may send a request to the DBMS for debugging information when a stored procedure is called. The user may then send a request to the web server for a web page. Before responding to the user with the web page, the web server may request information from the DBMS by calling a stored procedure. The DBMS may send debugging information to the IDE and receive debugging instructions from the IDE during execution of the stored procedure. Once the stored procedure is completed, any resulting information is sent from the DBMS to the web server. The web server then uses this information to complete the web page requested by the user and send it to the user.

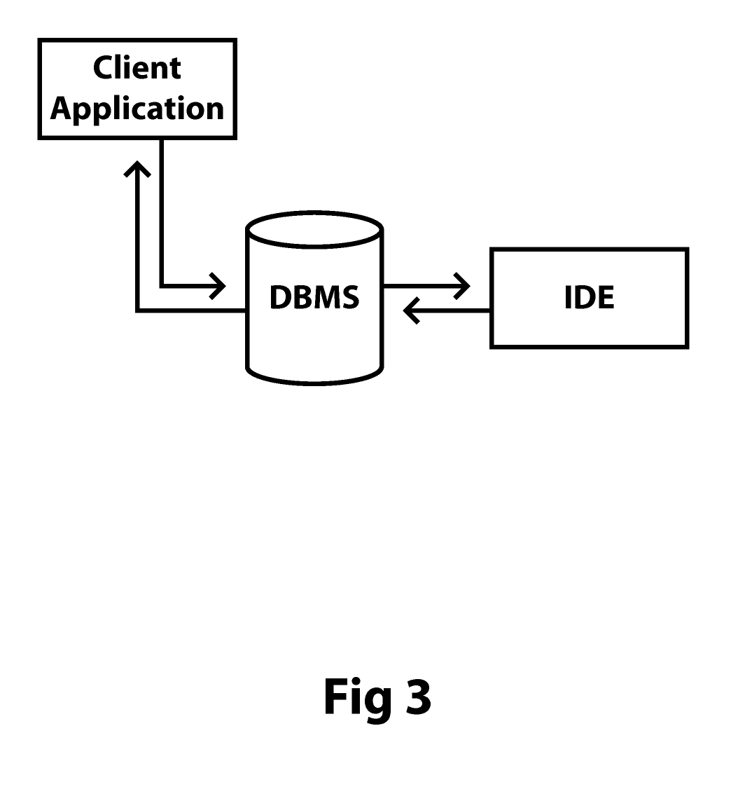

FIG. 3 shows an example of the structure of a system that uses a stored procedure that may be debugged using the invention. The system includes a client application, a DBMS and an IDE. The IDE may send a request to the DBMS for debugging information when a stored procedure is called. The client application may request information from the DBMS by calling a stored procedure. The DBMS may send debugging information to the IDE and receive debugging instructions from the IDE during execution of the stored procedure. Once the stored procedure is completed, any resulting information is sent from the DBMS to the client application.

Debugging a stored procedure may allow a developer to inspect and control the details of the execution in order to ensure that it is working as intended and to devise ways of amending the stored procedure to achieve the expected results. When the stored procedure being debugged is implemented in an imperative language, such as C, Lua or SQL/PSM, debugging may include allowing the developer to step through the code as it executed. The developer may be able to inspect the execution line by line, or may set points where execution should pause so that the execution environment can be inspected. The developer may be able to see the value of variables declared in the code as well as environmental variables. In an embodiment of the invention, the developer is also able to modify variables while execution is paused. The developer may also be able to modify the code of the stored procedure while execution is paused.

When the stored procedure is implemented using a declarative language, such as ML or Prolog, the developer may be able to inspect the declarative statements as they are relied upon to derive the result of the stored procedure. In this case, the developer may similarly be able to inspect the relevant contextual information, such as variables, and pause and resume the execution.

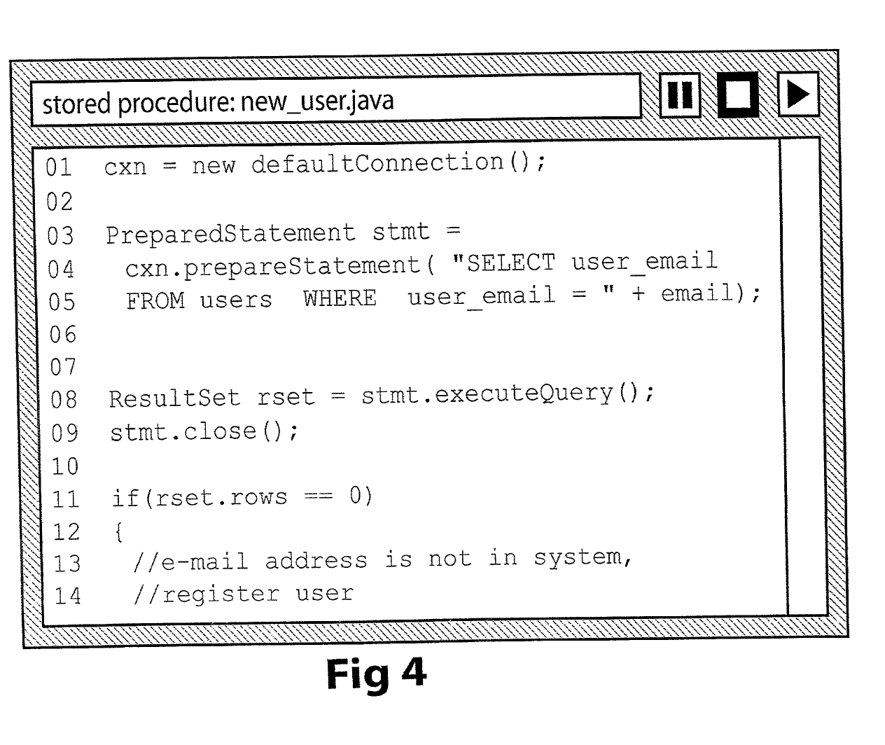

Debugging of a stored procedure may be invoked from an Intergrated Development Environment (IDE). The IDE may be a software development environment, such as Eclipse or Microsoft Visual Studio. In an embodiment of the invention, the IDE is a fully fledged software development tool that in addition to debugging can be used to author code, and deploy the finalized stored procedure to the DBMS. It may then comprise a text-editor, a compiler, and a means for communicating with the database server. FIG. 4 shows an integrated development environment (IDE) displaying the code of a stored procedure titled “new_user.java” in accordance with an embodiment of the invention. The stored procedure shown is implemented in Java.

In order to debug a stored procedure on a DBMS, the user of the IDE may specify a network address for the database server, such as an IP address or a fully qualified domain name along with a username and password. In an embodiment of the invention, the user is then presented with a list of databases available on the DBMS. The user may then select one of these databases, and further be presented with a list of stored procedures associated with the selected database. The list of stored procedures may also include statistical information about the number of calls made to a stored procedure over a particular period of time.

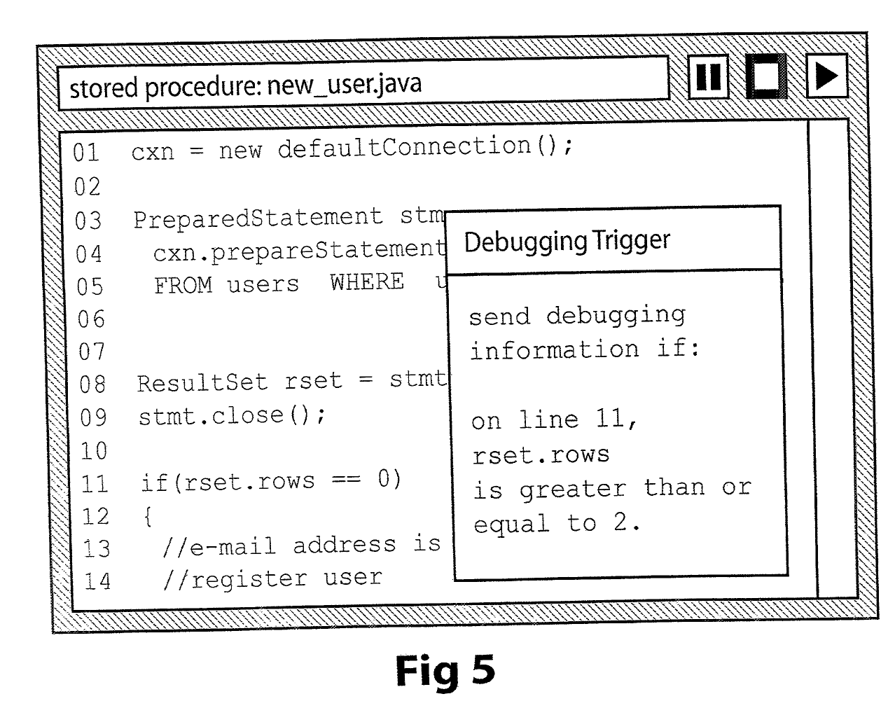

In order to debug the stored procedure, the user may select the stored procedure from a menu, or open it to view a representation of the associated code. The user may then proceed by specifying criteria identifying which calls to invoke the stored procedure should be debugged. The user may be presented with a dialog allowing the user to specify such criteria. In an embodiment of the invention, this dialog includes a fixed number of fields for which the user can specify values, such as username of the DBMS account used to invoke the procedure, and parameters used to call the procedure. In another embodiment, the dialog comprises a list of criteria the user can add arbitrary criteria. FIG. 5 shows an IDE with a dialog allowing a user to specify conditions for which calls to the stored procedure should trigger debugging in accordance with an embodiment of the invention. The particular dialog lets the developer freely specify arbitrary criteria. The developer has specified that if execution reaches line 11 and the variable “rset.rows” is greater than or equal to 2, debugging should start and debugging information should be sent to the IDE.

In an embodiment of the invention, the IDE requests debugging information for all calls to the selected stored procedure. The request may specify that notification should only be sent when the stored procedure was invoked with a debugging flag enabled. If the stored procedure is located on a production server, or is implemented in such a way that it will be invoked very frequently this may limit the number of concurrent debugging sessions to a number which the developer can manage. The developer may be debugging a stored procedure by invoking requests from a particular client application. If that client application is configured to flag its requests to invoke stored procedures with a debugging flag, the developer may be able to see only debugging information relating to requests invoked from that client application. In another embodiment of the invention, the IDE may request to be notified only when a stored procedure is called by a particular user account on the database server or when other conditions are met. Examples of such conditions include context information such as the number of queries currently pending on the server, the CPU load of the server, the amount of memory available on the server, and the load of the network interface on the server. Furthermore the conditions can relate to the actual content of the request to call the procedure. In an embodiment of the invention, a stored procedure taking three arguments (first name; last name; e-mail) is being debugged. The request for debugging information may specify that debugging information should only be sent for calls where the e-mail address is in the “.us” domain, or where the e-mail address is not formatted properly.

Furthermore, in an embodiment of the invention, the request for debugging information may specify that debugging information should only be sent if certain conditions within the code are met. Such conditions may indicate that debugging should only start if execution of a particular segment of code in the stored procedure is reached, or is an internal variable in the stored procedure has a particular value at a particular point in the code.

In an embodiment of the invention, the user may specify criteria or which calls to the stored procedure should invoke the debugging functionality from a window showing the code of the stored procedure. The user may be able to select various elements of the code to specify criteria. The user may for instance click a reference to a variable and chose to set a criteria. For example, a user may click a reference to a variable called tCount on row 58 of the code and specify that if the value of the variable is greater than 99, debugging should be started.

Once the user is done specifying criteria the IDE may send the request for debugging information to the DBMS. Before sending the request, the IDE may inform the user of the number of requests that meet the criteria received at the DBMS every hour, and let the user modify the criteria if the number of conforming requests is too high. The user may see a dialog with the message: “The criteria you have specified will result in starting debugging for approximately 200 requests to the stored procedure per minute. Do you want to continue?” If the user confirms, the request is sent to the DBMS.

Upon receiving the request for debugging information, the DBMS may begin monitoring requests to invoke stored procedures to determine which requests will require debugging information to be sent to the IDE.

In an embodiment of the invention, debugging instructions are sent to the engine that executes the stored procedure. The debugging instructions may include breakpoints which instruct the debugger to pause the execution of the procedure when certain events occur, for instance when a certain line of code is executed, or when certain types of execution errors occur. When the code supplied is Java code or Lua code, the breakpoints may be specified with respect to the actual code, or the intermediary language code that is executed by the virtual machine. Debugging instructions may also include instructions to track the value of certain variables, whether at the point of hitting a breakpoint, or over the time of the execution, such that when a break point is hit, the developer can step back line by line to see how the variables change. Debugging instructions may also include requests to track other information such as the CPU stack or registers or other instructions relating to execution of the code. A breakpoint may be defined in the stored procedure code to let the execution module know when to pause execution.

The stored procedure may be implemented in the Lua scripting language. The Lua scripting language has a corresponding compiler, interpreter and Virtual Machine (VM). In other embodiments of the invention, stored procedures may be in languages that are directly interpreted during execution or compiled into machine code. Lua scripts may access APIs written in the C language, including the standard Lua core API and the Lua auxiliary API. In an embodiment of the invention, an additional API is used to communicate between the script and the DBMS.

When a Lua script is executed it may first be compiled into an intermediate binary format and then executed by the Lua VM. The scripts can be precompiled or compiled on the fly. The Lua compiler is a single pass compiler that can compile code line by line as it is supplied to the compiler, enabling it to simulate execution of the script by interpretation. The Lua bytecode is a series of instructions for the VM. The VM will interpret the bytecode by executing each individual instruction.

Executing an instruction may comprise issuing a set of instructions native to the system the script is currently executing on which correspond to the Lua binary instruction. Some instructions, for example the GETTABLE instruction which fetches an element from a table-structure and inserts it into a register, may be executed by calling a predefined routine outside the script.

Interpreting binary code, as opposed to executing it by just-in-time compilation may afford greater control over the code flow. In an embodiment of the invention, the VM is modified in order to integrate it with a DBMS via an execution control module such that the DBMS can obtain information about a script being executed and control the flow of the code. In another embodiment of the invention, there is no direct integration between the VM and the DBMS, but control of execution is handed to the DBMS by including an API call achieving the same in the script. In an embodiment of the invention such an API call is implemented in the C language and integrated with Lua in the same manner as the other C libraries are.

The Lua scripting language and the Lua binary language are closely related and optimized for use in concert. Some Lua binary instructions relate to particular data-structures and concepts in the Lua scripting language, including the GETTABLE, SETTABLE and NEWTABLE instructions relating to the table data-structure and the CALL, TAILCALL and RETURN instructions relating to Lua closures. It is possible to create a mapping between the script-code and the binary code such that the line of code in the script-code being executed can be determined by knowing the position of the execution pointer in the binary code. Similarly, it is possible to determine the value of variables, including tables, by inspecting memory addresses and register or stack values from the VM. When implemented using Lua version 5, which is register based, the methods will map accordingly.

In an embodiment of the invention, debugging instructions are sent to a virtual machine (VM), such as the Lua VM or Java VM, before executing the stored procedure. The VM may then control execution of the code itself, and notify a debugging module of the code flow and of available debugging information. For example, when the VM determines that it is about to execute a line of code that is marked as a break point, it may pause execution of the code and notify the debugging module and send it all the relevant debugging information. When the code is directly interpreted, such as when a stored procedure implemented in PSQL is executed on Microsoft SQL server, a similar implementation may be used.

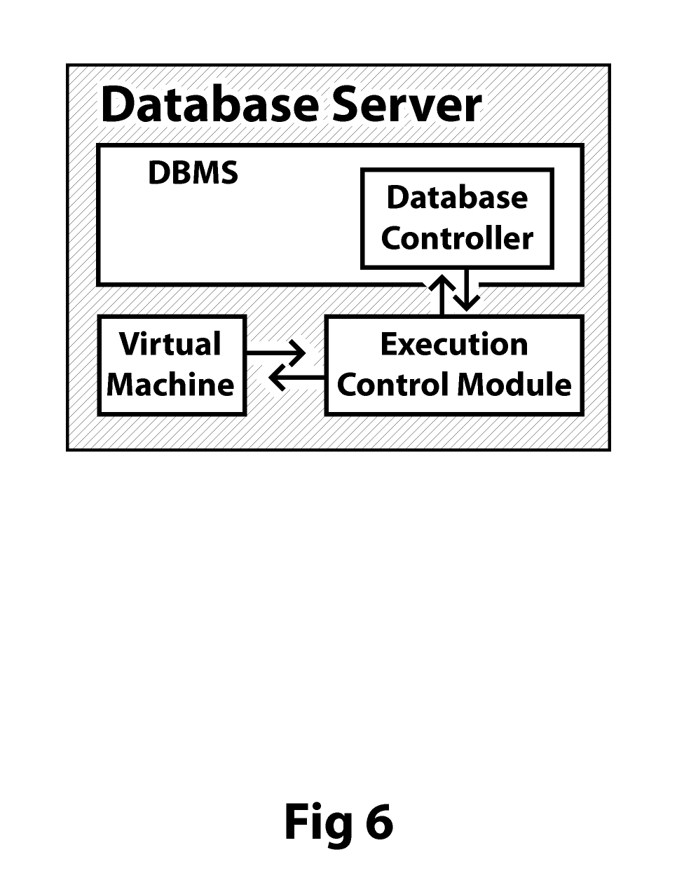

FIG. 6 depicts a diagram showing the internal structure at a database server in an embodiment of the invention. The database server includes a DBMS which in turn includes a database controller. The server also includes a virtual machine to execute a stored procedure and an execution control module which controls the execution of the stored procedure by the VM, and which can send debugging information to an IDE and receive debugging instructions from an IDE. The database controller can instruct the execution control module to start executing a stored procedure.

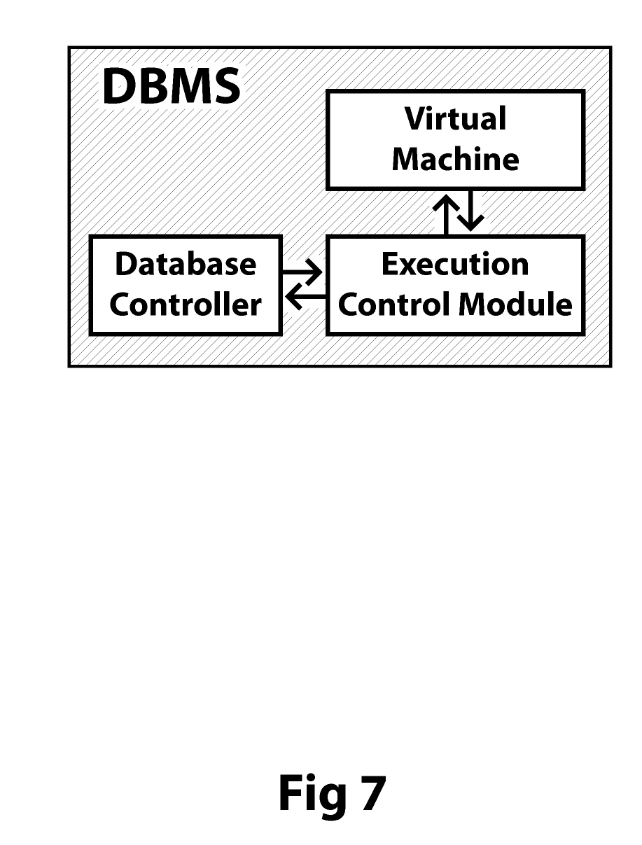

FIG. 7 depicts a diagram showing the internal structure at a DBMS in an embodiment of the invention. The DBMS includes a database controller, and execution module and a virtual machine. The database controller can start execution of the stored procedure once the DBMS receives a request to invoke it, by instructing the execution control module to execute it on the virtual machine. Since the virtual machine is integrated into the DBMS it may access data in the database directly. The database controller may receive debugging instructions from an IDE and send debugging information to an IDE.

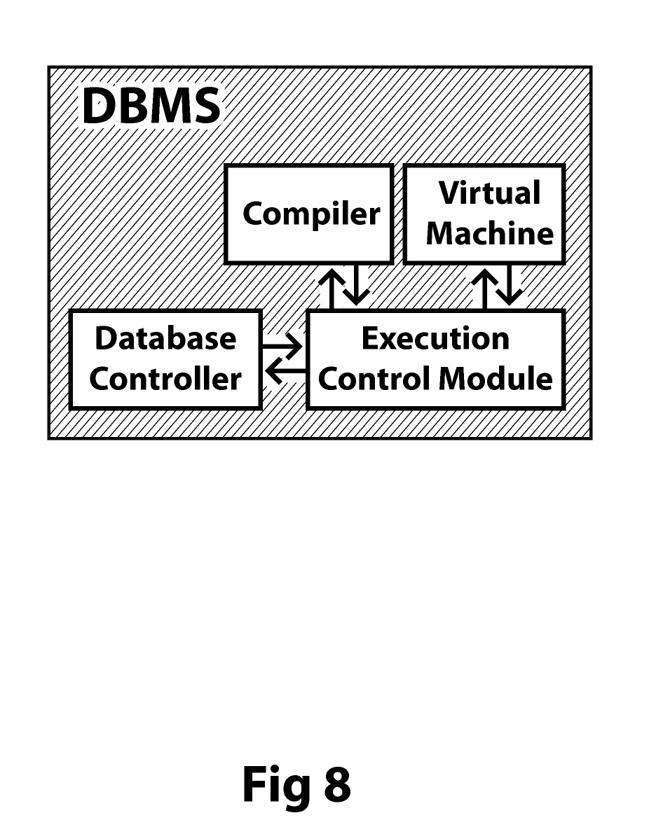

FIG. 8 depicts a diagram showing the internal structure at a DBMS in an embodiment of the invention. The DBMS includes a database controller, an execution control module, a compiler and a virtual machine. The database controller can start execution of the stored procedure once the DBMS receives a request to invoke it, by instructing the execution control module to execute it. The execution control module may execute the stored procedure by retrieving the source code, and send a portion of it to the compiler, and receive bytecode back from the compiler, and in turn send it to the virtual machine. It may continue by compiling the next portion of the code if it determines to continue executing the code. Since the virtual machine is integrated into the DBMS it may access data in the database directly. The database controller may receive debugging instructions from an IDE and send debugging information to an IDE.

In addition to or in place of sending debugging instructions to an interpreter, virtual machine or other execution module, an execution control and execution control module may be used. In an embodiment of the invention, a stored procedure is implemented in PSQL and executed using an interpreter. The interpreter may notify the execution control module after executing each line of code. The execution control module may then determine whether to continue execution of the stored procedure or pause execution based on debugging instructions. The debugging module may also send debugging information to the IDE, and receive further debugging instructions from the IDE.

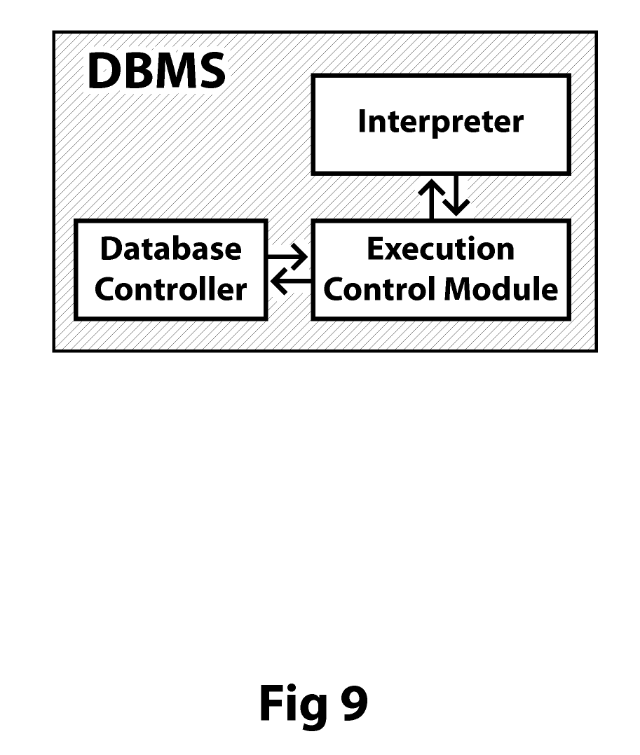

FIG. 9 depicts a diagram showing the internal structure at a DBMS in an embodiment of the invention. The DBMS includes a database controller, an execution control module and an interpreter. The database controller can start execution of the stored procedure once the DBMS receives a request to invoke it, by instructing the execution control module to execute it. The execution control module may execute the stored procedure by retrieving the source code, and sending the code, piece by piece, to the interpreter for execution by interpretation. Since the interpreter is integrated into the DBMS it may access data in the database directly. The database controller may receive debugging instructions from an IDE and send debugging information to an IDE.

The execution control module may deliberately slow down execution to a speed such that a human can following the execution of the code line by line, and send debugging information to the IDE continuously such that the developer can intervene as he observes the stored procedure execute.

In an embodiment of the invention, the stored procedure is compiled into machine code for the computer on which it is to execute. For example, a stored procedure to be executed on an Intel Itanium machine may be compiled into the IA-64 machine code. For debugging purposes the code may be compiled with certain debugging hooks in the code that return control of execution to an execution control module. In an embodiment of the invention this handover is achieved using a branch instruction. The execution control module may interface with the IDE including sending debugging information to the IDE and receiving further debugging instructions from it. The execution control module may then resume executing the stored procedure when it is appropriate to do so.

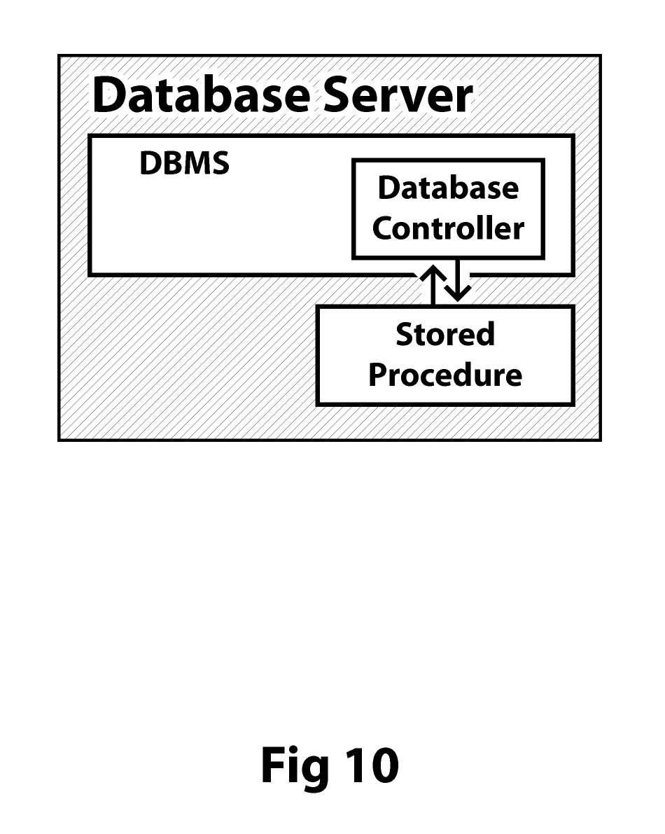

FIG. 10 depicts a diagram showing the internal structure at a database server in an embodiment of the invention. The database server includes a DBMS which in turn includes a database controller. The server also includes a stored procedure compiled into native machine code for the database server. The database controller can start execution of the stored procedure once the DBMS receives a request to invoke it. The stored procedure can access information in the database by communicating with the database controller via a shared API. The database controller can also control the execution of the stored procedure via a shared debugging API. The database controller may receive debugging instructions from an IDE and send debugging information to an IDE.

In one embodiment of the invention, all stored procedures executed on the database server are executed in debug mode. In another embodiment of the invention, only certain calls to invoke a stored procedure will result in execution in debug mode. The server may determine to execute a stored procedure in debug mode once it determines that there is a possibility that the call may result in debugging information being requested by an IDE. For example when whether to send debugging information depends on internal variables in the stored procedure, it may be necessary to execute the stored procedure in debug mode in order to determine whether to send debugging information, and only some of the stored procedure calls executed in debug mode thereby result in debugging information being sent to the IDE.

Once the DBMS has determined that debugging information should be sent to the IDE, execution of the stored procedure may be paused on the server while such information is sent to the IDE. The IDE may then display the code of the stored procedure with a visual indication of where the execution pointer is, as well as additional information regarding the context, such as values of variables, and relevant rows from database tables.

The developer may then inspect the code and contextual information to determine how to proceed. If not terminating execution altogether, the developer may move the execution pointer, change data in the database, change the values of variables, or change the code of the stored procedure. Once the developer has made the appropriate changes, the developer may chose to resume execution.

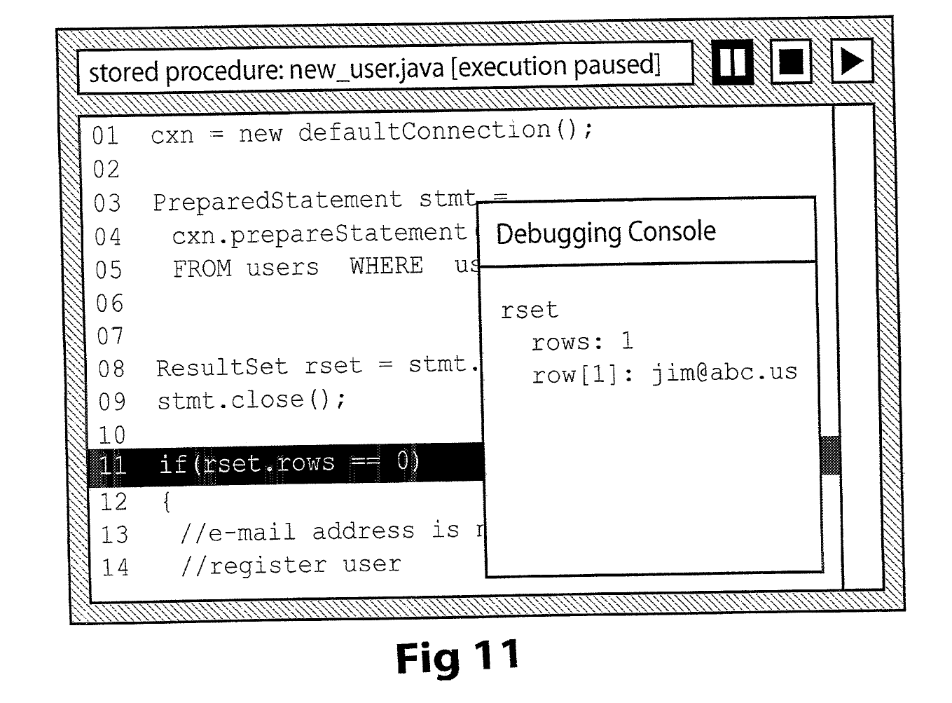

FIG. 11 shows an IDE during debugging of the stored procedure “new_user.java” in accordance with an embodiment of the invention. The black shading of line 11 indicates that execution has been paused and that line 11 will be the next line to be executed when execution is resumed. The “Debugging Console” window shows information about the object “rset”; it contains a variable “rows” with a value of “1”, and it contains a row of data with the value “jim@abc.us”.

The IDE may then send the developer's instructions to the DBMS, and the DBMS may resume execution of the stored procedure until it completed, or until it determines that debugging information should be sent to the IDE again.

If the user modifies the code of the stored procedure, the IDE must send a new representation of the code to the DBMS. If the stored procedure is executed directly by interpretation, such as when Microsoft SQL server executed T-SQL stored procedures, it may be sufficient to send the modified code. When the stored procedure is compiled it may be necessary to update the line-references and variable-reference between the lines in the human-readable code and the machine code before sending these compiled code and references to the DBMS. If may also be necessary to rearrange memory used by the stored procedure to correspond with new references in the updated machine code. If compilation is done at the DBMS, the references may be updated there, and it may only be necessary to send the updated code from the IDE.

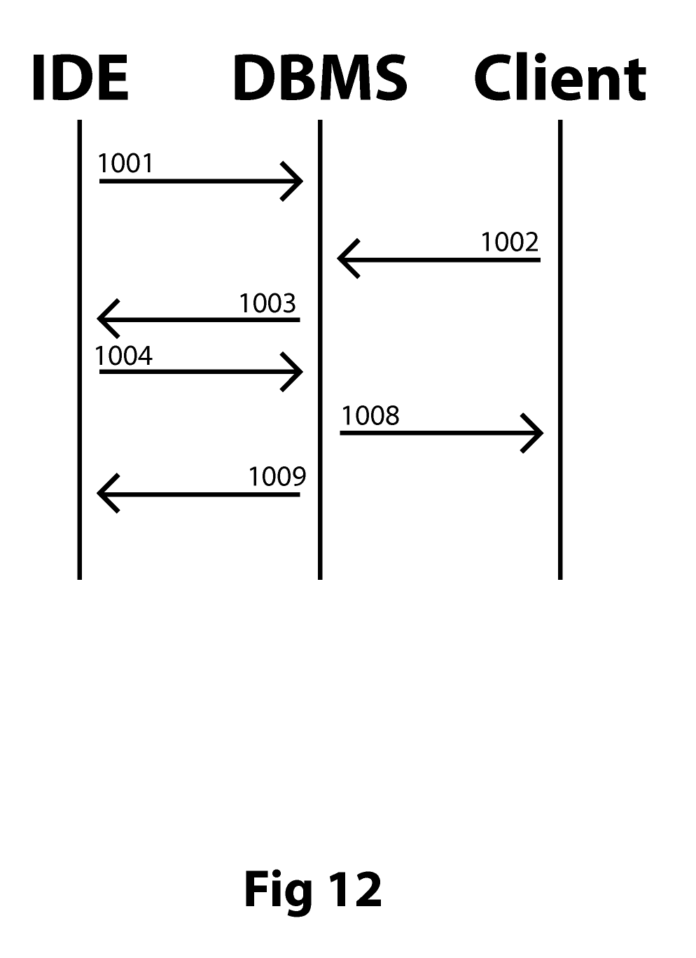

FIG. 12 shows the communications between an IDE, a DBMS and a Client in an embodiment of the invention. The IDE sends a request for debugging information (1001) to the DBMS. The client then sends a request to invoke a stored procedure (1002) to the DBMS. Upon invoking the stored procedure, the DBMS sends debugging information (1003) and pauses execution. The IDE sends additional debugging instructions (1004) to the DBMS including an instruction to resume execution. This pattern (1003 and 1004) may repeat until execution of the stored procedure is completed, and the DBMS sends the results of the stored procedure (1005) to the client, and the DBMS sends the last debugging information to the IDE (1006).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for debugging a stored procedure on a database server comprising, at the database server:
receiving, from an IDE, a request to be notified when debugging information is available while the stored procedure is being interpreted;
receiving, from a client application, a request to interpret the stored procedure in debug mode;
instructing an interpreter to execute a line of code; and
receiving notification from the interpreter that the execution is complete;
determining that a break-point in the stored procedure is reached;
in response to determining that a break-point in the stored procedure is reached, sending debugging information to the IDE, the debugging comprising at least one of: the source code of the stored procedure, a value of a local variable, a value of a global variable, the location of the break-point, or a combination thereof;
receiving debugging instructions from the IDE, the debugging instructions comprising at least one of: a new value for a local variable, a new value for a global variable, a change to the source code of the stored procedure, a new location for the execution pointer, or a combination thereof;
resuming interpreting the stored procedure according to the received debugging instructions; and
sending output from the stored procedure to the client application.

2. A method for debugging a stored procedure on a database server comprising, at the database server:
receiving, from an IDE, a request to be notified when debugging information is available while the stored procedure is being interpreted;
receiving, from a client application, a request to interpret the stored procedure;
interpreting the stored procedure;
determining that a break-point in the stored procedure is reached;
in response to determining that a break-point in the stored procedure is reached, sending debugging information to the IDE;
receiving debugging instructions from the IDE;
resuming interpreting the stored procedure according to the received debugging instructions; and
sending output from the stored procedure to the client application.

3. The method of claim 2, wherein the step of interpreting the stored procedure comprises:
at an execution control module, until it is determined that a break-point had been reached:
instructing an interpreter to execute a line of code;
receiving notification from the interpreter that the execution is complete;
determining whether the next line of code is a break-point.

4. The method of claim 2 wherein the client-application communicates with the database using JDBC.

5. The method of claim 2 wherein the stored procedure residing on the database server is in SQL.

6. The method of claim 2 wherein the stored procedure residing on the database server is in LUA.

7. The method of claim 2, wherein initiating the debug session with the IDE comprises sending a wake-up message to the IDE.

8. A method for debugging a stored procedure on a database server comprising, at the database server:
receiving, from an IDE, a request to be notified when debugging information is available;
receiving, from a client-application, a request to execute a stored procedure in debug mode;
interpreting a first line of code in the stored procedure;
initiating the debug session with the IDE;
repeating, until the end of the stored procedure is reached:
sending debugging information to the IDE;
receiving debugging instructions from the IDE; and
resuming interpreting of the stored procedure according to an instruction in the received debugging instructions; and
sending the result of the stored procedure to the client-application.

9. The method of claim 8 wherein sending debugging information to the IDE comprises sending information about the location of the breakpoint reached.

10. The method of claim 8 wherein sending debugging information to the IDE comprises sending values of local variables.

11. The method of claim 8 wherein sending debugging information to the IDE comprises sending values of global variables.

12. The method of claim 8 wherein sending debugging information to the IDE comprises sending the source code of the stored procedure to the IDE.

13. The method of claim 8 wherein receiving debugging instructions from the IDE comprises receiving a new value for a local variable.

14. The method of claim 8 wherein receiving debugging instructions from the IDE comprises receiving a new value for a global variable.

15. The method of claim 8 wherein receiving debugging instructions from the IDE comprises receiving instructions to resume execution at a different point.

16. The method of claim 8 wherein receiving debugging instructions from the IDE comprises receiving new source code from the IDE.

17. The method of claim 8, wherein the step of interpreting the first line of code comprises:
at an execution control module, until it is determined that a break-point had been reached:
instructing an interpreter to execute a line of code;
receiving notification from the interpreter that the execution is complete;
determining whether the next line of code is a break-point.

18. The method of claim 8 wherein the client-application communicates with the database using JDBC.

19. The method of claim 8 wherein the stored procedure is written in SQL.

19. The method of claim 8 wherein the stored procedure is written in LUA.

20. The method of claim 8, wherein initiating the debug session with the IDE comprises sending a wake-up message to the IDE.

21. A method for debugging a stored procedure on a database server comprising: at the database server:
receiving, from an IDE, a request to be notified when debugging information is available while the stored procedure is being interpreted;
receiving, from a client application, a request to interpret the stored procedure in debug mode;
interpreting the stored procedure;
determining that an exception occurred while interpreting the stored procedure;
in response to determining that an exception occurred, sending debugging information to the IDE;
receiving debugging instructions from the IDE;
resuming interpreting the stored procedure according to the received debugging instructions; and
sending output from the stored procedure to the client application.

22. The method of claim 21 wherein sending debugging information to the IDE comprises sending values of local variables.

23. The method of claim 21 wherein sending debugging information to the IDE comprises sending values of global variables.

24. The method of claim 21 wherein sending debugging information to the IDE comprises sending the source code of the stored procedure to the IDE.

25. The method of claim 21 wherein receiving debugging instructions from the IDE comprises receiving a new value for a local variable.

26. The method of claim 21 wherein receiving debugging instructions from the IDE comprises receiving a new value for a global variable.

27. The method of claim 21 wherein receiving debugging instructions from the IDE comprises receiving instructions to resume execution at a different point.

28. The method of claim 21 wherein receiving debugging instructions from the IDE comprises receiving new source code from the IDE.

29. The method of claim 21 wherein the client-application communicates with the database using JDBC.

30. The method of claim 21 wherein the stored procedure is written in SQL.

31. The method of claim 21 wherein the stored procedure is written in LUA.

32. The method of claim 21, wherein initiating the debug session with the IDE comprises sending a wake-up message to the IDE.

33. The method of claim 21, wherein the step of interpreting the stored procedure comprises:
at an execution control module, until it is determined that a break-point had been reached:
instructing an interpreter to execute a line of code;
receiving notification from the interpreter that the execution is complete;
determining whether the next line of code is a break-point.

34. The method of claim 33 wherein sending debugging information to the IDE comprises sending information about the location of the last line of code the interpreter was instructed to execute before it was determined that an exception occurred.
